(19) United States
(12) Patent Application Publication
(10) Pub. No.: US 2006/0213238 A1
(43) Pub. Date: Sep. 28, 2006

(54) Electronic steering wheel lock, and electronic ignition switch for motor vehicles

(76) Inventors: Stefan Thronberens, Adelzhausen (DE); Werner Trischberger, Langenpettenbach (DE)

Correspondence Address: BACON & THOMAS, PLLC, 625 SLATERS LANE, FOURTH FLOOR, ALEXANDRIA, VA, 22314, US

(21) Appl. No.: 10/565,189

(22) PCT Filed: Jul. 2, 2004
(86) PCT No.: PCT/EP04/07222

§ 371 Date: Jan. 20, 2006

(30) Foreign Application Priority Data
Jul. 28, 2003 (DE) 10334335.0

(51) Int. Cl. B60R 25/02

(52) U.S. Cl. 70/186

(57) ABSTRACT

Disclosed is an electronic steering wheel lock for motor vehicles, comprising a rotor (5) that is rotatable within a stator (2) from an initial position and back into said initial position so as to move a locking member (3) back and forth between a steering shaft-locking position and a steering shaft-releasing position. In its initial position, said rotor (5) can be coupled in a positive manner to the stator (2) under the effect of a spring load (22) while being movable within the stator (2) in an axial direction against the effect of the spring load (22) by means of an electromagnet (7) disposed coaxially to the rotor (5) in order to cancel the mutual engagement between the rotor (5) and the stator (2) and allow the locking member (3) to be moved into the steering shaft-releasing position when the electromagnet (7) is excited with the aid of an electronic key. The rotor (5) is provided with at least one coupling dog (23) which cooperates with a coupling slot (24) of the stator (2). Said coupling slot (24) is delimited by an inertial element (26) on the side towards which the rotor (5) is rotatable within the stator (2) from the initial position thereof. The inertial element (26) can be displaced within the stator (2) along with the rotor (5) against the effect of a spring load (27) when the rotor (5) is moved in axial direction against the effect of the spring load (22) thereof as a result of a blow being inflicted on the stator (2). Said mechanism of protection against blow effects can also be provided in a corresponding electronic ignition and starting switch for motor vehicles.

The invention relates to an electronic steering wheel lock and an electronic ignition and starting switch for motor vehicles, of the type defined by the preambles of claims 1 and 6, respectively.

An electronic motor vehicle steering wheel lock and an electronic motor vehicle ignition and starting switch of these kinds are known (German Patent Specification DE-C 199 57 624). They are sensitive to external blows on the stator, because such force impacts can cause an axial displacement of the rotor out of its coupled position with the stator, against the action of its spring load, so that the rotor can be rotated out of its initial position without the electromagnet having been excited by using the electronic key associated with the steering wheel lock or respectively the ignition and starting switch.

The object of the invention is to provide an electronic steering wheel lock and an electronic ignition and starting switch for motor vehicles, of the type defined by the preambles of claims 1 and 6, respectively, with a mechanism of protection against blow effects, so that the rotor cannot become disengaged from the stator as a result of external blows on the stator and then rotated out of its initial position.

This object is attained by the features recited in the characterizing portions of claims 1 and 6, respectively. Advantageous improvements of the electronic motor vehicle steering wheel lock of the invention are recited in claims 2 through 5, and advantageous improvements of the electronic motor vehicle ignition and starting switch of the invention are recited in claims 7 through 10.

One embodiment of the electronic steering wheel lock for motor vehicles according to the invention is described below by way of example in conjunction with drawings. In the drawings:

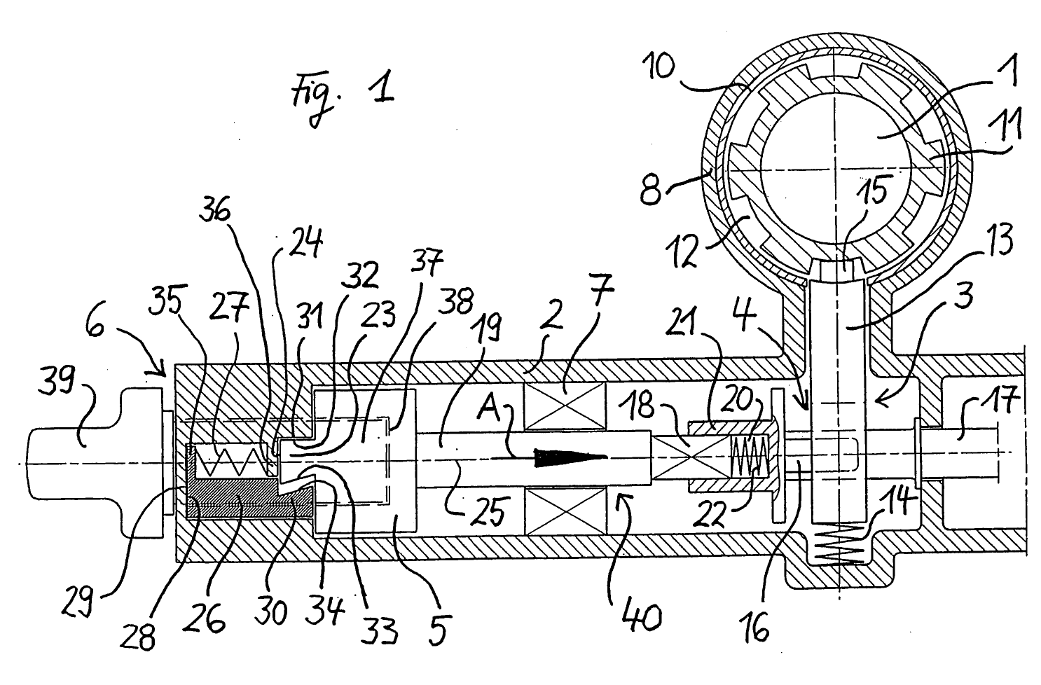

FIG. 1 shows a longitudinal section along the longitudinal axis of the rotor and the longitudinal axis of the locking member, the rotor being locked in its initial position in the stator and the locking member being in its steering shaft locking position;

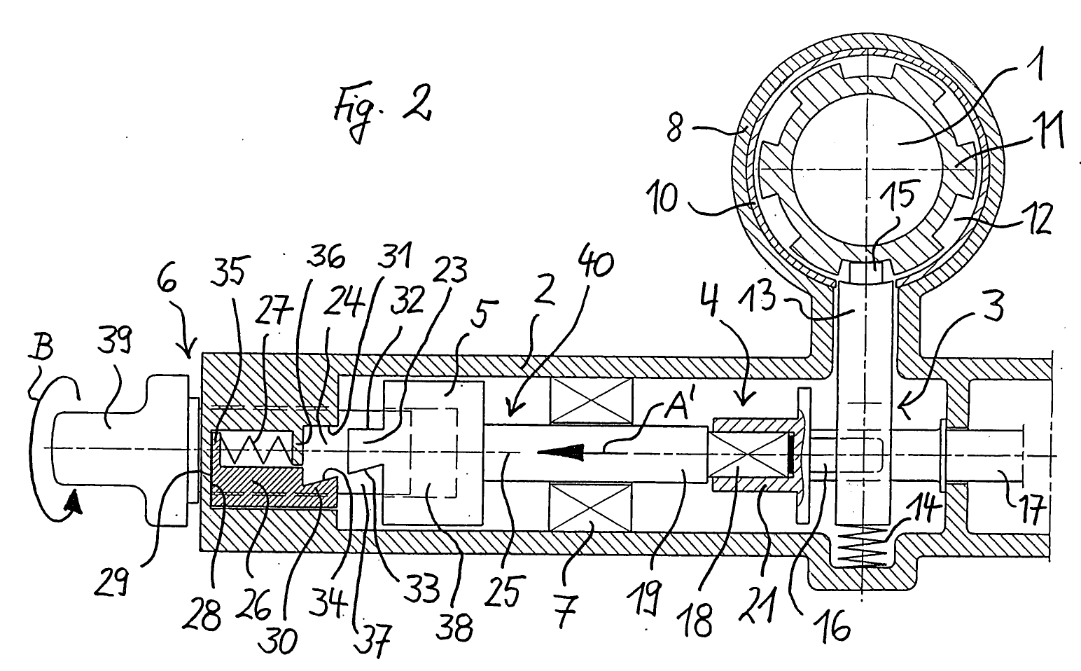

FIG. 2 shows a longitudinal section corresponding to that of FIG. 1, with the rotor having been unlocked by means of the electromagnet;

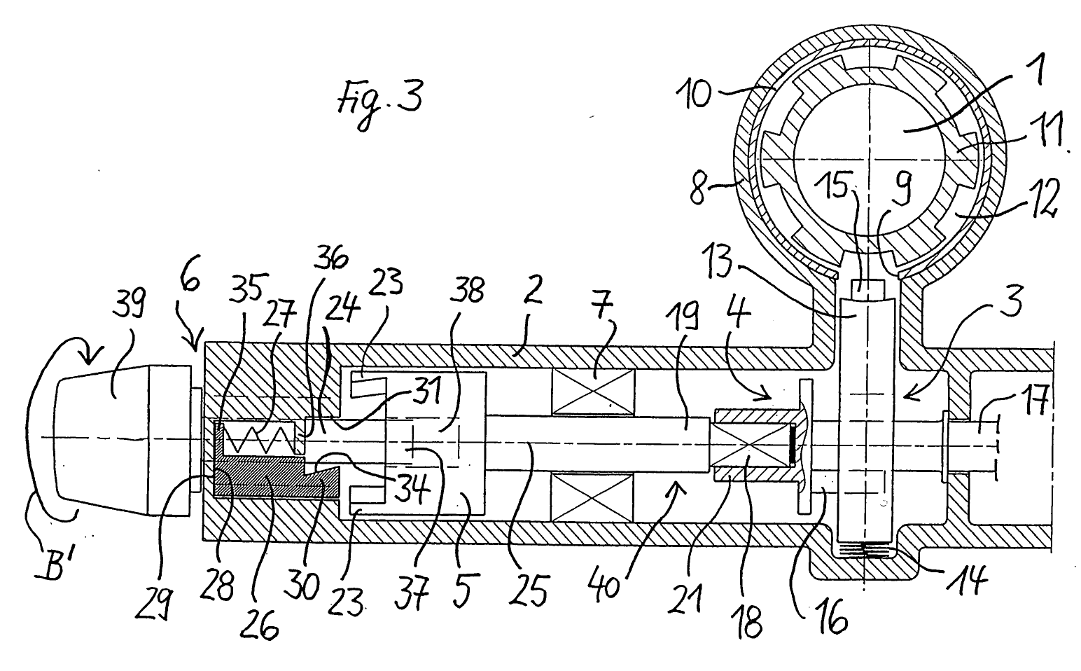

FIG. 3 shows a longitudinal section corresponding to that of FIG. 2, in which the rotor has been rotated 90° clockwise, and the locking member is in its steering shaft releasing position;

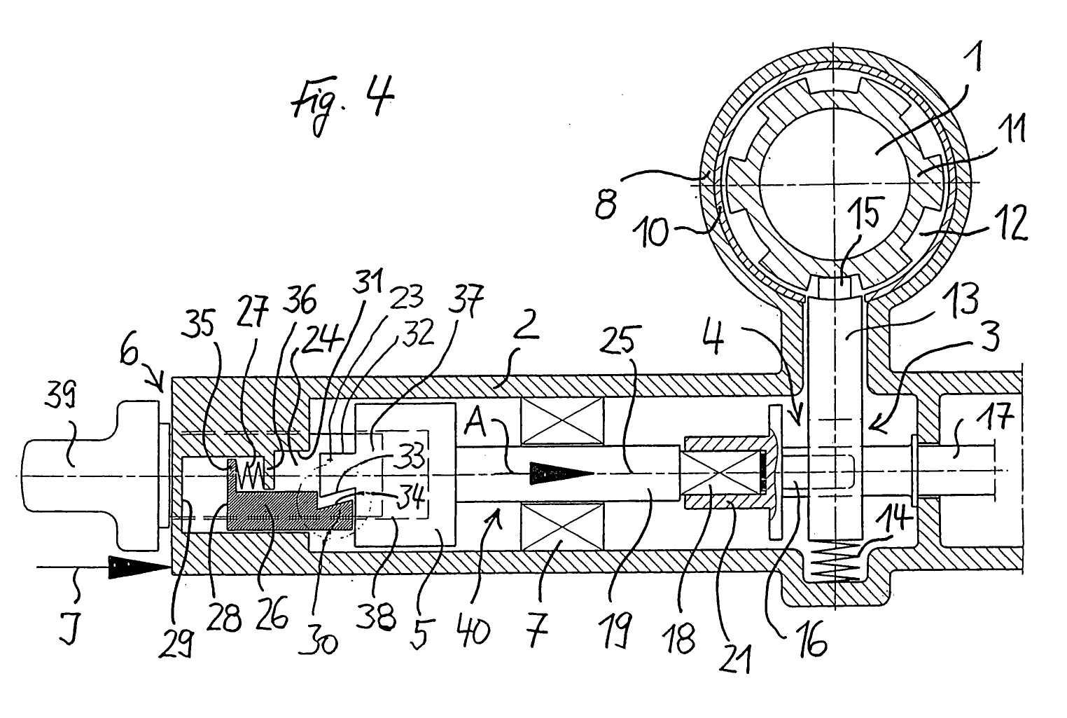

FIG. 4 shows a longitudinal section corresponding to that of FIG. 1, in which the rotor has been displaced, as a result of an external blow on the stator, into the axial position in the stator visible in FIG. 2.

The electronic steering wheel lock shown for locking the steering shaft 1 of a motor vehicle against rotation has a stator 2, a locking member 3, a control member 4, a rotor 5, an actuation member 6, and an electromagnet 7, and can be unlocked by means of an electronic remote-control key, not shown.

The stator 2 is formed as a housing for the locking member 3, control member 4, rotor 5, actuation member 6, and electromagnet 7, and is secured by means of a sleevelike portion 8 to a jacket tube 10, which is provided with a passage opening 9 for the locking member 3 and which surrounds the steering shaft 1 and a locking sleeve 11, secured to the steering shaft 1, and having slotlike locking recesses 12, with which the locking member 3 cooperates. The sleevelike portion 8 of the stator 2 rests on the outer surface of the jacket tube 10.

The locking member 3 is formed by a locking bolt 13, which extends perpendicular to the steering shaft 1 and is supported for axial displacement in the stator 2. The locking bolt 13 is urged in the direction toward the steering shaft 1 into the steering shaft locking position of FIGS. 1 and 2, by a helical compression spring 14, which rests on one end against the stator 2 and on the other end against the locking bolt 13, in which position the locking bolt 13, with its free end 15, engages a locking recess 12 of the locking sleeve 11, so that the steering shaft 1 cannot be rotated. The locking bolt 13 also is movable by means of the control member 4, against the action of the helical compression spring 14, away from the steering shaft 1 into the steering shaft releasing position of FIG. 3, in which the locking bolt 13, with its free end 15, does not engage any locking recess 12 of the locking sleeve 11, and thus the steering shaft 1 can be rotated.

The control member 4 is formed like a rod, extends transversely to the locking bolt 13 through an opening in it, not shown, has an eccentric 16 for moving the locking bolt 13, and cooperates, on the end 17 remote from the rotor 5, with an ignition and starting switch, not shown. The control member 4 is rotatable in the stator 2 out of the rotary position of FIGS. 1 and 2 clockwise into the rotary position of FIG. 3 and back again to the rotary position of FIGS. 1 and 2.

The rotor 5 cooperates with the control member 4, in order to rotate the control member. It is located coaxially with the control member 4 in the stator 2 and is supported both rotatably and axially displaceably in the stator 2 and engages with the free end 18 of square cross section of a rodlike axial extension 19, a blind bore 20 of corresponding cross-sectional shape of the control member 4, which is provided in the end 21 of the control member 4 adjacent to the eccentric 16.

Within the stator 2, the rotor 5 is rotatable clockwise out of the initial position of FIGS. 1, 2 into the rotary position of FIG. 3 and back into the initial position of FIGS. 1, 2 and is also movable axially back and forth between the axial position of FIG. 1 and the axial position of FIGS. 2 and 3. In its initial position, the rotor 5, under the influence of a helical compression spring 22 that is located in the blind bore 20 of the control member 4, can be coupled positively with the stator 2 so that it cannot be rotated. To that end, the rotor 5 has two diametrically opposed, axially protruding coupling dogs 23 for engagement in two diametrically opposed coupling slots 24 of the stator 2, which extend parallel to the longitudinal axis 25 of the rotor 5.

Each coupling slot 24 of the stator 2, on the side toward which the rotor 5 can be rotated out of its initial position, is defined by an inertial element 26 which is supported displaceably in the stator 2 parallel to the longitudinal axis 25 of the rotor and is urged by a helical compression spring 27 into the rest position of FIGS. 1 through 3. In this position, the inertial element 26, with the end face 28 facing away from the rotor 5, abuts a counter face 29 of the stator 2 and, with the end 30 adjacent to the rotor 5, is located facing the side flank 31 provided on the stator 2 of the coupling slot 24. While this side flank 31 of the coupling slot 24 and the side face 32, which in the axial position of FIG. 1 of the rotor 5 in the stator 2 is oriented toward the side flank 31, of the coupling dog 23 of the rotor 5 associated with the coupling slot 24 extend parallel to the longitudinal axis 25 of the rotor, the two side faces 33 and 34 facing one another and extending parallel to one another, of the coupling dog 23 and the inertial element 26, respectively, on the end 30 of the inertial element adjacent to the rotor 5, extend obliquely to the longitudinal axis 25 of the rotor, so that when the side faces 33, 34 are pressed together, the rotor 5 and the inertial element 26 are urged axially toward one another. The helical compression spring 27 that urges the inertial element 26 into its rest position is disposed parallel to the inertial element 26 and is supported on one end on the inertial element 26 and on the other end on the stator 2, namely on one end on a lateral protrusion 35 of the inertial element 26, which is provided on its end remote from the rotor 5 and having the end face 28, and on the other end on an inner protrusion 36 of the stator 2 that forms the bottom of the coupling slot 24.

The actuation member 6 serves to rotate the rotor 5 by hand. It is rotatably supported in the stator 2, and with its inner end 37 of rectangular cross section it engages a blind bore 38 of corresponding cross-sectional shape of the rotor 5, and it has an external handle 39.

The electromagnet 7 cooperates with the rotor 5 to displace the rotor 5 axially, against the action of the helical compression spring 22, in the stator 2 when the electromagnet 7 is excited. The electromagnet 7 is located in the stator 2 coaxially with the control member 4 and with the rotor 5, specifically between the control member 4 and the rotor 5. The electromagnet 7 has an axially movable armature 40, which extends through the electromagnet 7 and is formed by the axial extension 19 of the rotor 5.

The electronic steering wheel lock for motor vehicles shown functions as follows.

In the steering wheel lock condition of FIG. 1, the locking bolt 13 is in the steering shaft locking position, so that the steering shaft 1 cannot be rotated. The rotor 5 is locked in its initial position in the stator 2, so that it cannot be rotated either, since its two coupling dogs 23 engage the two coupling slots 24 of the stator 2.

To move the locking bolt 13 into its steering shaft releasing position, in which the steering shaft 1 can be rotated, the aforementioned electronic remote-control key is actuated, which causes the excitation of the electromagnet 7, so that electric current flows through its annular coil surrounding the armature 40 and the electromagnet 7 moves the rotor 5 in the direction of the arrow A in FIG. 1, against the action of its helical compression spring 22. Simultaneously, the coupling dogs 23 of the rotor 5 move out of the coupling slots 24 of the stator 2, so that the rotor 5 can be rotated in the stator 2. There results the steering wheel lock condition shown in FIG. 2.

Next, the unlocked rotor 5 is rotated out of its initial position in the stator 2, jointly with the control member 4, in the direction of the arrow B in FIG. 2 with the aid of the actuation member 6, in order to move the locking bolt 13 into its steering shaft releasing position by means of the eccentric element 16 of the control member 4, against the action of its helical compression spring 14. There results the steering wheel lock condition shown in FIG. 3.

To allow the locking bolt 13 to return to the steering shaft locking position, the rotor 5 and the control member 4 are rotated with the aid of the actuation member 6 out of the common rotary position of FIG. 3 in the direction of the arrow B′ back into the common initial position of FIG. 2, in which the rotor 5 can be pushed by its helical compression spring 22 in the direction of the arrow A′ back into the position shown in FIG. 1 where it is coupled with the stator 2, so that as a consequence of the engagement of its coupling dogs 23 with the coupling slots 24 of the stator 2, the rotor 5 cannot be rotated and is again locked in the stator 2.

The two inertial elements 26 which are associated with the two coupling slots 24 of the stator 2 that are diametrically opposite one another with respect to the longitudinal axis 25 of the rotor act in the steering wheel lock condition of FIG. 1 as a mechanism protecting against blow effects, because they prevent the rotor 5 from becoming disengaged from the stator 2 as a result of external blows on the stator 2, which disengagement would allow the rotor to be rotated out of its initial position in the stator 2. The inertial elements 26 accordingly make it impossible for the rotor 5 in the stator 2 to be unlocked without excitation of the electromagnet 7.

As can be seen from FIG. 4, an external blow or force impact J, parallel to the longitudinal axis 25 of the rotor, on the end of the stator 2 which is adjacent to the rotor 5 and from which the handle 39 of the actuation member 6 protrudes causes both an axial displacement of the rotor 5, against the action of its helical compression spring 22, and an axial displacement of the two inertial elements 26, against the action of the respective helical compression spring 27. Accordingly, the rotor 5 and the inertial elements 26 are displaced in common in the direction of the arrow A in the stator 2, so that the two ends 30, adjacent to the rotor, of the inertial elements 26 always extend in front of the two coupling dogs 23 of the rotor 5, which are diametrically opposite one another relative to the longitudinal axis 25 of the rotor, and block any rotation of the rotor 5 in the stator 2 out of its initial position clockwise; the wedge action of the two oblique side faces 33 of the coupling dogs 23 of the rotor 5 and of the two oblique side faces 34 of the ends 30 of the inertial elements 26 reinforces the holding together of the rotor 5 and the inertial elements 26.

An electronic ignition and starting switch for motor vehicles can be designed accordingly, in which for switching on and off, in particular, the motor vehicle ignition system and the motor vehicle starter, the rotor 5 is rotatable in the stator 2 out of its initial position into various switching positions and back into the initial position.

1. An electronic steering wheel lock for motor vehicles, which can be unlocked by means of an electronic key, comprising a locking member for locking the motor vehicle steering shaft against rotation and a rotor that is rotatable out of an initial position and back into the initial position for moving the locking member back and forth between a steering shaft locking position and a steering shaft releasing position in a stator, wherein the rotor cannot be rotated out of the initial position, so that the locking member moves into the steering shaft releasing position, until an electromagnet, disposed in the stator coaxially with the rotor, has been energized with the aid of the electronic key, in order to unlock the rotor, which in its initial position, under the influence of a spring load, can be coupled positively with the stator and is axially displaceable in the stator by means of the electromagnet against the action of the spring load in order to release the mutual engagement of the rotor and the stator, and further wherein the rotor has at least one coupling dog, which cooperates with a coupling slot of the stator, which slot is defined, on the side toward which the rotor is rotatable out of its initial position, by an inertial element which is displaceable in the stator together with the rotor against the action of a spring load when the rotor (5), as a consequence of a blow on the stator, is axially displaced against the action of its spring load.

2. The steering wheel lock according to claim 1, wherein two side faces, extending parallel to one another and oriented toward one another, of the coupling dog of the rotor and of the inertial element of the stator, extend obliquely to the longitudinal axis of the rotor, so that when the side faces are pressed against one another, the rotor and the inertial element are loaded axially toward one another.

3. The steering wheel lock according to claim 1, wherein the coupling dog of the rotor protrudes axially from the rotor, and the coupling slot of the stator extends parallel to the longitudinal axis of the rotor.

4. The steering wheel lock according to claim 1, wherein the inertial element of the stator is loaded into its rest position by a helical compression spring, which is supported on one end on the inertial element and on the other end on the stator.

5. The steering wheel lock according to claim 1, wherein the rotor has two diametrically opposed coupling dogs, which each cooperate with a respective coupling slot of the stator, which slot is defined laterally by an inertial element.

6. An electronic ignition and starting switch for motor vehicles, which can be unlocked by means of an electronic key, comprises a rotor, which for switching on and off, in particular the ignition system and the starter of the motor vehicle, is rotatable in a stator out of an initial position into various switching positions and back into the initial position, wherein the rotor cannot be rotated into the switching positions until an electromagnet, disposed in the stator coaxially with the rotor, has been excited with the aid of the electronic key in order to unlock the rotor, which in its initial position, under the influence of a spring load, can be coupled positively with the stator, and is axially displaceable in the stator by means of the electromagnet against the action of the spring load in order to release the mutual engagement of the rotor and the stator, wherein the rotor has at least one coupling dog, which cooperates with a coupling slot of the stator, which slot is defined, on the side toward which the rotor is rotatable out of its initial position, by an inertial element which is displaceable in the stator together with the rotor against the action of a spring load when the rotor, as a consequence of a blow on the stator, is axially displaced against the action of its spring load.

7. The ignition and starting switch according to claim 6, wherein two side faces, extending parallel to one another and oriented toward one another, of the coupling dog of the rotor and of the inertial element of the stator extend obliquely to the longitudinal axis of the rotor, so that when the side faces are pressed against one another, the rotor and the inertial element are loaded axially toward one another.

8. The ignition and starting switch according to claim 6, wherein the coupling dog of the rotor protrudes axially from the rotor, and the coupling slot of the stator extends parallel to the longitudinal axis of the rotor.

9. The ignition and starting switch according to claim 6, wherein the inertial element of the stator is loaded into its rest position by a helical compression spring, which is supported on one end on the inertial element and on the other end on the stator.

10. The ignition and starting switch according to claim 6, wherein the rotor has two diametrically opposed coupling dogs, which each cooperate with a respective coupling slot of the stator, which slot is defined laterally by an inertial element.
